(19) United States
(12) Patent Application Publication
(10) Pub. No.: US 2013/0106898 A1
(43) Pub. Date: May 2, 2013

(54) DETECTING OBJECT MOVING TOWARD OR AWAY FROM A COMPUTING DEVICE

(71) Applicants: Emmanuel René Saint-Loubert-Bié, Redwood City, CA (US); Mitsuru Oshima, San Jose, CA (US)

(72) Inventors: Emmanuel René Saint-Loubert-Bié, Redwood City, CA (US); Mitsuru Oshima, San Jose, CA (US)

(73) Assignee: Google Inc., Mountain View, CA (US)

(21) Appl. No.: 13/282,323

(22) Filed: Oct. 26, 2011

(51) Int. Cl. G06F 3/01; G09G 5/02; G09G 5/00

(52) U.S. Cl. 345/592; 345/156; 345/676; 345/684

(57) ABSTRACT

A computer-implemented method for receiving input from a user is disclosed according to an aspect of the subject technology. The method comprises detecting an object moving toward a screen of the computing device. The method also comprises, in response to detecting the object moving toward the screen, displaying a virtual input device on the screen, and receiving input from the user via the virtual input device.

### FIELD

The subject disclosure generally relates to computing devices, and, in particular, to detecting an object moving toward or away from a computing device.

### BACKGROUND

A computing device (e.g., smart phone, tablet, etc.) may display a virtual input device (e.g., a virtual keyboard) on a screen to allow a user to input text and/or commands into the device. However, the computing device may have a limited screen size, which limits the amount of information that can be displayed on the screen. The amount of information that can be displayed is further limited when the virtual input device is displayed on the screen.

### SUMMARY

A computer-implemented method for receiving input from a user is disclosed according to an aspect of the subject technology. The method comprises detecting an object moving toward a screen of the computing device. The method also comprises, in response to detecting the object moving toward the screen, displaying a virtual input device on the screen, and receiving input from the user via the virtual input device.

A machine-readable medium is disclosed according to an aspect of the subject technology. The machine-readable medium comprises instructions stored therein, which when executed by a machine, cause the machine to perform operations. The operations comprise detecting an object moving toward an input field on a screen of a computing device. The operations also comprise, in response to detecting the object moving toward the input field on the screen, displaying a virtual input device on the screen, and receiving input from the user via the virtual input device.

A system for receiving input from a user is disclosed according to an aspect of the subject technology. The system comprises one or more processors, and a machine-readable medium comprising instructions stored therein, which when executed by the one or more processors, cause the one or more processors to perform operations. The operations comprise detecting a finger or hand moving toward a screen of a computing device. The operations also comprise, in response to detecting the finger or hand moving toward the screen, displaying a virtual input device on the screen, and receiving input from the user via the virtual input device.

A computer-implemented method for controlling an opacity of a virtual input device displayed on a computing device is disclosed according to an aspect of the subject technology. The method comprises detecting a distance of an object from a screen of the computing device, and adjusting the opacity of the virtual input device based on the detected distance of the object from the screen of the computing device.

A computer-implemented method for loading content onto a computing device is disclosed according to an aspect of the subject technology. The method comprises detecting an object moving toward a link on a screen of the computing device, wherein the link corresponds to content on a network. The method also comprises, in response to detecting the object moving toward the link on the screen, retrieving the content from the network using the link, and storing the retrieved content on the computing device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 is a conceptual block diagram of a computing device according to an aspect of the subject technology.

FIG. 2A shows a front view of the computing device according to an aspect of the subject technology.

FIG. 2B shows a side view of the computing device according to an aspect of the subject technology.

FIG. 2C is a conceptual block diagram of an object positioning device according to an aspect of the subject technology.

FIG. 3A shows an example of a text box displayed on a screen of the computing device according to an aspect of the subject technology.

FIG. 3B shows an example of the text box and a virtual input device displayed on the screen of the computing device according to an aspect of the subject technology.

FIG. 3C shows an example of a user's finger approaching the screen of the computing device according to an aspect of the subject technology.

FIG. 4 is a flowchart of a process for receiving input from a user according to an aspect of the subject technology.

FIG. 5 is a flowchart of a process for controlling the opacity of a virtual input device according to an aspect of the subject technology.

FIG. 6 is a flowchart of a process for loading content onto the computing device according to an aspect of the subject technology.

FIG. 7 shows an example of a split virtual keyboard according to an aspect of the subject technology.

FIG. 8 shows an example of a virtual game controller according to an aspect of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

A computing device (e.g., smart phone, tablet, etc.) may display a virtual input device (e.g., a virtual keyboard) on a screen to allow a user to input text and/or commands into the device. However, the computing device may have a limited screen size, which limits the amount of information that can be displayed on the screen. The amount of information that can be displayed is further limited when the virtual input device is displayed on the screen.

To address these limitations, the user may have the virtual input device displayed on the screen only when the user needs to use the virtual input device. For example, the user may bring up the virtual input device on the screen by touching a hard or soft key that activates the virtual input device. When the user is finished using the virtual input device, the user may remove the virtual input device from the screen by touching a hard or soft key that deactivates the virtual input device. Alternatively, the virtual input device may automatically be removed after a timeout (no user input for a set amount of time). However, the user may find it inconvenient to have to touch a hard or soft key to bring up the virtual input device each time the user needs to enter text and/or commands into the computing device using the virtual input device.

Systems and methods according to various aspects of the subject technology allow a user to bring up a virtual input device on the screen without having to touch a hard or soft key. The virtual input device may include a virtual keyboard, a virtual game controller, and/or other virtual input device.

In one aspect, the computing device includes a positioning device configured to determine the distance and/or position of a user's finger/hand relative to the screen without the finger/hand physically touching the screen. In this aspect, the computing device may automatically display the virtual input device on the screen when the positioning device detects the user's finger/hand approaching the screen. Thus, when the user moves his finger/hand toward the screen to enter text and/or commands into the device, the virtual input device automatically appears on the screen. Correspondingly, the computing device may automatically remove the virtual input device from the screen when the positioning device detects the user's finger/hand moving away from the screen. Thus, when the user moves his finger/hand away from the screen after entering text and/or commands into the computing device, the virtual input device automatically disappears from the screen to provide more space on the screen for displaying information.

In another aspect, the computing device may control the opacity of the virtual input device based on the distance of the user's finger/hand from the surface of the screen. For example, the computing device may increase the opacity of the virtual input device when the user's finger/hand is closer to the surface of the screen and decrease the opacity of the virtual input device when the user's finger/hand is farther away from the surface of the screen.

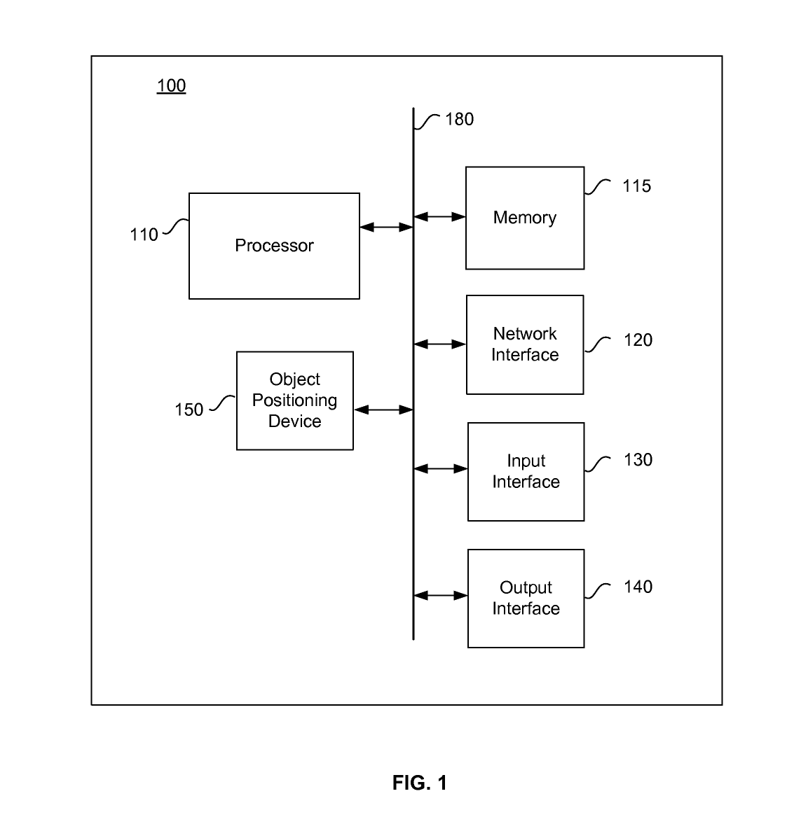

FIG. 1 shows a computing device 100 according to an aspect of the subject technology. The computing 100 device may be a tablet, a smart phone, or other type of computing device. While the computing device 100 is shown in one configuration in FIG. 1, it is to be understood that the computing device may include additional, alternative and/or fewer components.

In the example shown in FIG. 1, the computing device 100 includes a processor 110, a memory 115, a network interface 120, an input interface 130, an output interface 140, object positioning device 150, and a bus 180. The bus 180 collectively represents all system, peripheral, and chipset buses that communicatively connect the numerous components of the computing device 100. For instance, the bus 180 communicatively connects the processor 110 with the memory 115. The processor 110 may retrieve instructions from the memory 115 and execute the instructions to implement processes according to various aspects of the subject technology. The processor 110 may comprise a single processor or a multi-core processor in different implementations.

The memory 115 may comprise one or more memory units including non-volatile memory and volatile memory. For example, the memory 115 may include non-volatile memory for storing firmware, an operating system (OS), applications, and/or files. The memory 115 may also include volatile memory (e.g., a random access memory) for storing instructions and data that the processor 110 needs at runtime.

The input interface 130 enables a user to communicate information and commands to the computing device 100. For example, the input interface 130 may be coupled to a keypad and/or a pointing device (e.g., touch pad) to receive commands from the user. In another example, the input interface 130 may be coupled to a touch screen that receives commands from the user by detecting the presence and location of a user's finger/hand or stylus on the touch screen. The received commands may be sent to the processor 110 for processing.

The output interface 140 may be used to communicate information to the user. For example, the output interface 140 may output information from the processor 110 to the user on a display (e.g., liquid crystal display (LCD)). A touch screen may overlay the display to receive user commands. For example, the display may display a virtual input device, and the user may select a particular key or button on the virtual input device by touching the touch screen at a location corresponding the key or button.

The network interface 120 enables the computing device 100 to communicate with a network, for example, a local area network (“LAN”), a wide area network (“WAN”), an intranet, the Internet. The network interface 120 may include a wireless communication module for communicating with the network over a wireless link (e.g., WiFi wireless link, cellular wireless link, etc.).

The object positioning device 150 is configured to determine a position of an object relative to a display screen of the computing device 100. The object may be a user's finger or hand, a stylus, or other object. In the discussion that follows, an example of a user's finger/hand is used, although it should be appreciated that the subject technology is not limited to this example.

In one aspect, the object positioning device 150 may determine the position of the user's finger/hand as a set of coordinates in a three-dimensional coordinate system. In this aspect, the object positioning device 150 may determine the approximate position of a point on the user's finger/hand that is closest to the surface of the screen 220.

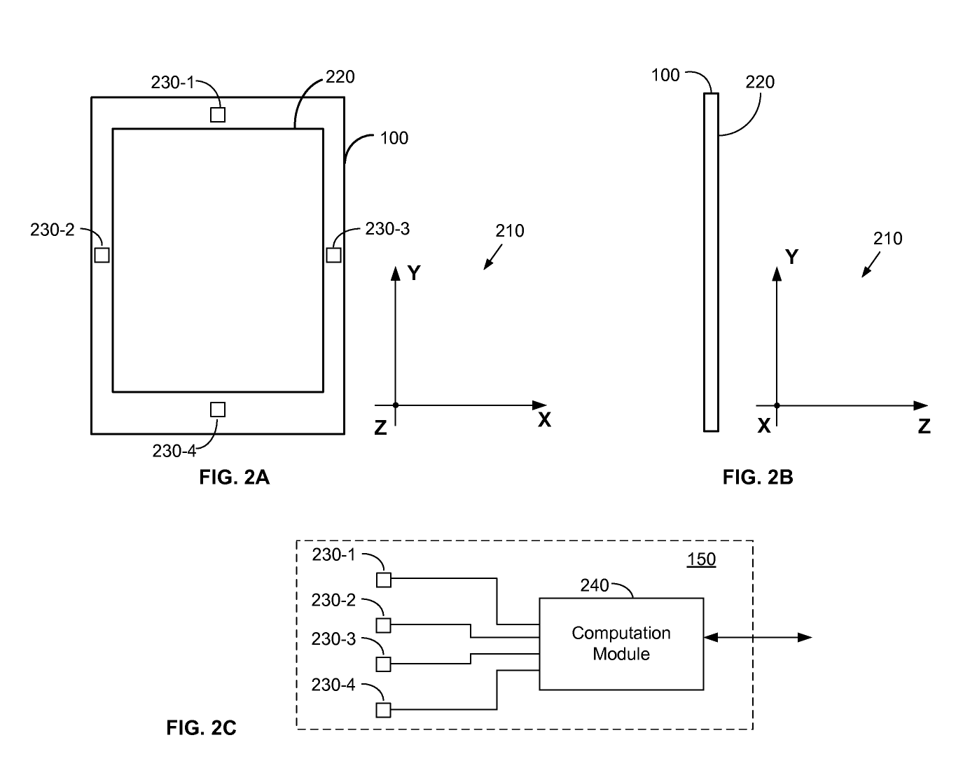

FIGS. 2A and 2B show an example of a three-dimensional coordinate system 210 with respect to a display screen 220 of the computing device 100. The coordinate system 210 may include x-y axes that are parallel to the surface of the screen 220, as shown in FIG. 2A. The coordinate system 210 also includes a z axis that is normal to the surface of the screen 220, as shown in FIG. 2B. In this example, the position of the user's finger/hand relative to the screen 220 may be given as x, y, z, coordinates where the z coordinate indicates the distance of the user's finger/hand from the surface of the screen 220 and the x and y coordinates indicate the position of the user's finger/hand on a two-dimensional plane that is parallel with the surface of the screen 220. It should be appreciated that the coordinate system 210 shown in FIGS. 2A and 2B is exemplary only, and that any suitable coordinate system may be used to represent the position of the user's finger/hand relative to the screen 220.

In one aspect, the object positioning device 150 may frequently determine the position of the user's finger/hand as the user moves his/her finger in front of the screen 220. For example, the object positioning device 150 may determine the position (e.g., x, y, z coordinates) of the user's finger/hand N times a second and output N positions a second (e.g., in a serial stream) to the processor 110, wherein N is an integer number. This allows the processor 110 to track the movements of the user's finger/hand in real time. For the example of the coordinate system 210 in FIGS. 2A and 2B, the processor 110 may determine whether the user's finger/hand is moving toward or away from the surface of the screen 220 by tracking changes in the z coordinate of the user's finger/hand.

In one aspect, the object positioning device 150 may comprise one or more distance sensing devices 230-1 to 230-4 and a computation module 240, as shown in FIG. 2C. The distance sensing devices 230-1 to 230-4 may be disposed at known positions along a perimeter of the screen 220, as shown in FIG. 2A. It should be appreciated that the number and arrangement of distance sensing devices shown in FIG. 2A is exemplary only, and that any suitable number and arrangement of distance sensing devices may be used (e.g., depending on the technology used for the distance sensing devices).

Each distance sensing device 230-1 to 230-4 may be configured to measure a distance between the distance sensing device and the user's finger/hand. The computation module 240 may compute the position of the user's finger/hand relative to the screen 220 based on distance measurements from the distance sensing devices 230-1 to 230-4 and the known positions of the distance sensing devices 230-1 to 230-4 relative to the screen 220. For example, the computation module 240 may triangulate the position of the user's finger/hand using three or more distance measurements from three or more distance sensing devices 230-1 to 230-4.

In another example, each distance sensing device 230-1 to 230-4 may be configured to determine the distance between the distance sensing device and the user's finger/hand in a certain direction (e.g., using a directional signal). In this example, the computation module 240 may determine the position of the user's finger/hand based on one or more distance measurements and the corresponding directions from the distance sensing devices 230-1 to 230-4 and the known positions of the distance sensing devices 230-1 to 230-4 relative to the screen 220.

Each distance sensing device 230-1 to 230-4 may measure the distance between the distance sensing device and the user's finger/hand N times a second, allowing the computation module 240 to compute the position of the user's finger/hand N times a second. The computation module 240 may output the position of the user's finger/hand N times a second (e.g., in a serial stream) to the processor 110 so that the processor 110 can track the movements of the user's finger/hand in real time. As discussed further below, the processor 110 may control various elements displayed on the screen 220 according to the tracked movements of the user's finger/hand. For example, the processor 110 may activate a virtual input device on the screen 220 when the processor 110 detects the user's finger/hand moving toward the screen 220 based on the positional data from the positioning device 150.

Each distance sensing device 230-1 to 230-4 may measure the distance between the distance sensing device and the user's finger/hand using any one of a variety of techniques. For example, a distance sensing device may determine the distance between the device and the user's finger/hand based on the time it takes a signal (e.g., ultrasound signal) emitted from the device to reflect off of the user's finger/hand and return to the device. The shorter the time, the shorter the distance between the distance sensing device and the user's finger/hand.

In another example, a distance sensing device may determine the distance between the device and the user's finger/hand by emitting a signal (e.g., infrared light) and measuring the intensity of a portion of the signal that is reflected back to the device from the user's finger/hand. The greater the measured intensity (e.g., received signal strength), the shorter the distance between the distance sensing device and the user's finger/hand.

In another example, a distance sensing device may determine the distance between the device and the user's finger/hand by emitting a signal at a certain angle and measuring an angle at which the signal returns to the device after being reflected back to the device from the user's finger/hand. In yet another example, the distance sensing device may determine the distance between the device and the user's finger/hand by emitting an amplitude modulated signal, detecting the return signal reflected back to the device from the user's finger/hand, and measuring a phase difference between the emitted signal and the return signal. In still another example, the distance sensing device may determine the distance between the device and the user's finger/hand by establishing an electromagnetic field in the vicinity of the device and detecting changes in the electromagnetic field caused by the presence of the user's finger/hand.

Those skilled in the art will appreciate that the distance measurement techniques described above are exemplary only and not intended to be exhaustive. A distance sensing device may employ any one of the techniques described above or other technique to measure distance. In one aspect, the distance sensing devices 230-1 and 230-4 may be configured to emit their respective signals at slightly different times to avoid potential interference between the devices.

In one aspect, the object positioning device 150 may comprise a wide-angle front-facing camera instead of or in addition to the plurality of distance sensing devices. In this aspect, the object positioning device 150 may acquire an image with the front-facing camera and process the image using an image recognition program to detect the user's finger/hand in the image. The object positioning device 150 may then determine the position of the user's finger/hand relative to the screen 220 based on the position and/or size of the user's finger/hand in the image. In this aspect, the acquired image may be sent directly to the processor 110 for processing by the processor 110 to determine the position of the user's finger/hand from the image.

Thus, the object positioning device 150 allows the processor 110 to track the movements of the user's finger/hand relative to the screen 220 without the user's finger/hand having to make physical contact with the screen 220. For example, the object positioning device 150 allows the processor 110 to determine whether the user's finger/hand is moving toward or away from the surface of the screen 220 when the user's finger/hand is not in physical contact with the screen 220.

In one aspect, the screen 220 may also comprise a touch screen. In this aspect, the processor 110 may use the touch screen to track movements of the user's finger/hand on the surface of the screen 220, and use the object positioning device 150 to track movements of the user's finger/hand when the user's finger/hand is not physically touching the screen 220. Thus, the processor 110 may switch between using the touch screen and the object positioning device 150 to track movements of the user's finger/hand, for example, depending on whether the user's finger/hand is touching the surface of the screen 220.

In one aspect, the processor 110 may use the positional data from the object positioning device 150 to determine when the user's finger/hand is approaching (moving toward) the surface of the screen 220. For example, the processor 110 may determine distances of the user's finger/hand from the surface of the screen 220 at two or more different times based on the positional data and determine that the user's finger/hand is approaching the surface of the screen 220 when the distances decrease over a time period. For the exemplary coordinate system 210 shown in FIGS. 2A and 2B, each distance may correspond to the respective z coordinate of the user's finger/hand.

Similarly, the processor 110 may use the positional data from the object positioning device 150 to determine when the user's finger/hand is moving away the screen 220. For example, the processor 110 may determine distances of the user's finger/hand from the surface of the screen 220 at two or more different times based on the positional data and determine that the user's finger/hand is moving away from the surface of the screen 220 when the distances increase over a time period.

Thus, the processor 110 may use the positional data from the object positioning device 150 to detect when the user's finger/hand is approaching or moving away from the surface of the screen 220. In one aspect, the processor 110 may display a virtual input device on the screen 220 when the processor 110 detects the user's finger/hand approaching the screen 220. In this aspect, the processor 110 may also require that the user's finger/hand approach the screen 220 over a certain distance (e.g., a few centimeters) before displaying the virtual input device to make sure that the user intends to touch the screen 220. The processor 110 may detect the user's finger/hand approaching the surface of the screen 220 when the user's finger/hand is still located a certain distance away from the surface of the screen 220. The distance may be one centimeter or more, two centimeters or more, three centimeters or more, or four centimeters or more.

The processor 110 may also remove the virtual input device from the screen 220 when the processor 110 detects the user's finger/hand moving away from the surface of the screen 220. In this case, the processor 110 may wait until the user's finger/hand is a certain distance away from the surface of the screen 220 before removing the virtual input device. This is because the user's finger/hand may move a small distance away from the surface of the screen 220 between keystrokes when the user is typing on a virtual keyboard.

In one aspect, the computing device 100 may have an input mode that the user may enable or disable (e.g., by pressing a soft or hard key). When the input mode is enabled, the processor 110 may automatically activate the virtual input device when the processor 100 detects the user's finger/hand approaching the surface of the screen 220.

In one aspect, the processor 110 may also determine a particular location on the screen 220 that the user's finger/hand is approaching. For example, when the processor 110 detects the user's finger/hand approaching the surface of the screen 220, the processor 110 may fit a line to different positions of the user's finger/hand taken at different times in three-dimensional space. The processor 110 may then estimate a particular location on the screen 220 that the user's finger/hand is approaching based on where the line intersects the surface of the screen 220.

In another example, the processor 110 may determine the position of the user's finger/hand on a two-dimensional plane that is parallel with the surface of the screen 220 and map that position to the surface of the screen 220 to estimate a particular location on the screen 220 that the user's finger/hand is approaching. For the exemplary coordinate system 210 shown in FIGS. 2A and 2B, the x and y coordinates may indicate the position of the user's finger/hand on the two-dimension plane parallel with the surface of the screen 220 while the z coordinate indicates the distance of the user's finger/hand from the surface of the screen 220. Thus, in this example, the processor 110 may estimate a particular location on the screen 220 that the user's finger/hand is approaching based on the x and y coordinates of the user's finger/hand, and estimate the distance of the user's finger/hand from the surface of the screen 220 based on the z coordinate of the user's finger/hand.

The processor 110 may use any one of the techniques described above or other technique to estimate a particular location on the screen 220 that the user's finger/hand is approaching.

In one aspect, the processor 110 may determine whether to display the virtual input device based on which location on the screen 220 the user's finger/hand is approaching. For example, the processor 110 may decide to display the virtual input device (e.g., virtual keyboard) when the user's finger/hand approaches a location on the screen 220 corresponding to an input field or other portion of the screen that requires the user to enter text. The input field may be a text box, a search box, or a uniform resource locator (URL) bar.

The processor 110 may decide not to display the virtual input device (e.g., virtual keyboard) when the user's finger/hand approaches a location on the screen 220 corresponding to a portion of the screen that does not require the user to enter text. For example, the processor 110 may decide not to display the virtual input device when the user's finger/hand approaches an icon, a scroll bar, a minimize button, a maximize button, or a link on the screen.

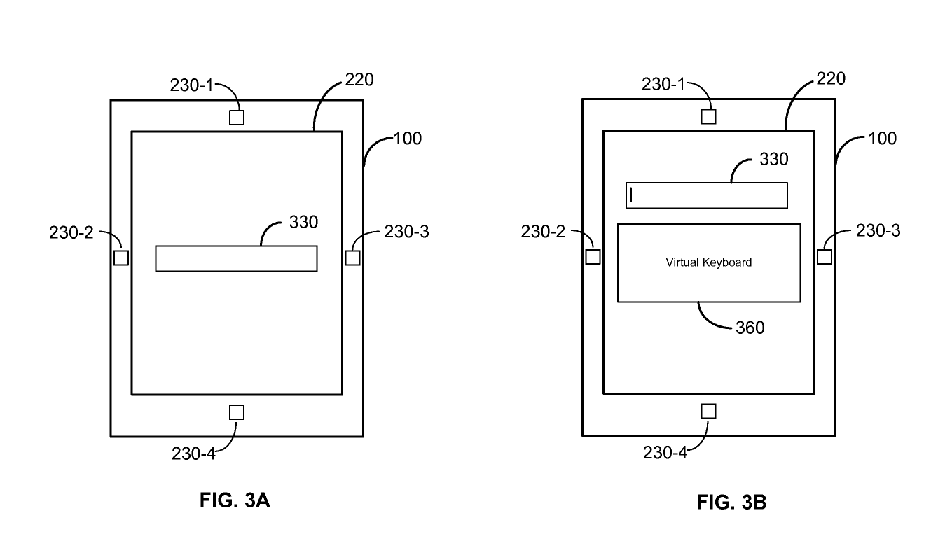

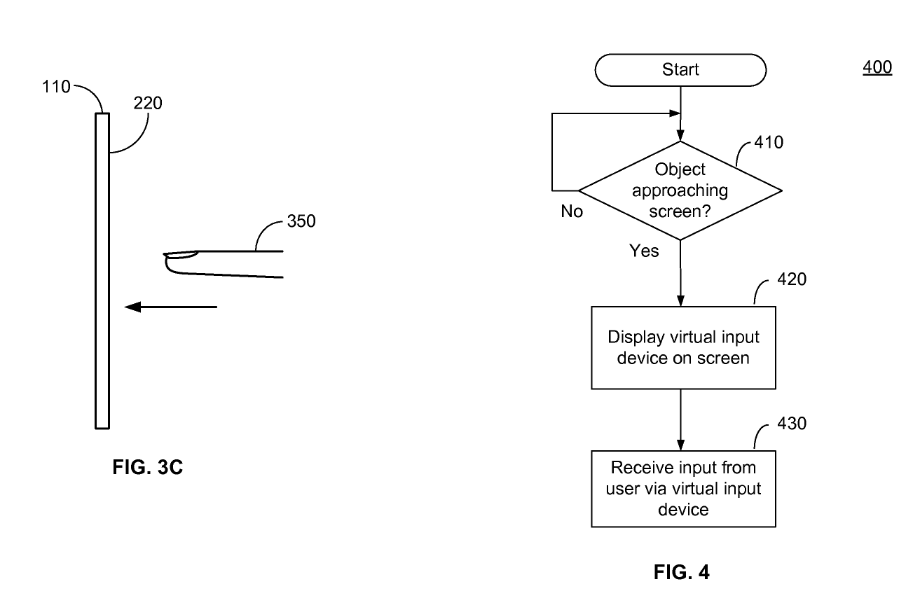

FIG. 3A shows an example of the computing device 100 with a text box 330 displayed on the screen 220. FIG. 3C shows a side-view of the computing device 100 with a user's finger 350 approaching the text box 130 on the screen 220 (indicated by the arrow in FIG. 3C). In this example, the processor 110 may determine that the user's finger 350 is approaching a location on the screen 220 corresponding to the text box 330 based on positional data from the object position device 150. In response to this determination, the processor 110 may display a virtual input device 360 on the screen 220 and bring the text box 330 into focus, as shown in FIG. 3B. In the example shown in FIGS. 3A and 3B, the virtual input device 360 is a virtual keyboard that allows the user to enter text into the text box 330 by typing on the virtual input device 360.

Thus, the processor 110 may infer that the user intends to enter text in the text box 330 when the processor 110 determines that the user's finger/hand is approaching the text box 330. The processor 110 may make this determination when the user's finger/hand is still located a certain distance away from the surface of the screen 220. The distance may be one centimeter or more, two centimeters or more, three centimeters or more, or four centimeters or more.

In one aspect, the processor 110 may display the virtual input device 360 at the location the user's finger/hand is approaching. For example, the processor 110 may center the virtual input device 360 at the location on the screen 220 that the user's finger/hand is approaching, as shown in the example in FIG. 3B. This allows the user to more quickly start typing on the virtual input device 360 when the user's finger/hand reaches the screen 220. In this aspect, the processor 110 may automatically reposition the text box 330 on the screen 220 away from the location so that the virtual input device 360 does not obstruct the text box 330, as shown in the example in FIG. 3B. Thus, when the user's finger/hand approaches the text box 330 on the screen 220, the processor 110 may display the virtual input device at the original location of the text box 330 and automatically reposition the text box 330 so that the virtual input device 360 does not obstruct the text box 330 and the user can view the text being entered in the text box 330.

The processor 110 may reposition the text box 330 by scrolling the text box 330 up or down on the screen 220. For example, as the user's finger/hand approaches the location of the text box 330, the processor 110 may begin scrolling the text box 330 up or down to make room for the virtual input device 360 at the location. In this example, when the text box 330 begins scrolling up or down, the user's finger/hand may continue to approach the original location of the text box 330 to bring up the virtual input device 360. The processor 110 may then display the virtual input device 360 at the original location of the text box 330.

Thus, when the user's finger/hand initially approaches the location of the text box 330, the processor 110 may determine that the user intends to enter text in the text box 330. The processor 110 may then scroll the text box 330 up or down and bring up the virtual input device 360 at the original location of the text box 330 so that the user may immediately begin typing on the virtual input device when the user's finger/hand reaches the screen 220.

In one aspect, the processor 110 may remove the virtual input device 360 from the screen 220 when the user is finished entering text. For an example of a search box, the processor 110 may automatically remove the virtual input device 360 after the user types a search term and hits the enter key. In another example, the processor 110 may remove the virtual input device 330 when the processor 110 detects the user's finger/hand moving away from the screen 220 based on positional data from the object positioning device 150. In this case, the processor 110 may wait until the user's finger/hand is a certain distance away (e.g., a few centimeters) from the surface of the screen 220 before removing the virtual input device 360. This is because the user's finger/hand may move a small distance away from the surface of the screen 220 between keystrokes when the user is typing on the virtual input device 360.

FIG. 4 is a flowchart of a process for receiving input from a user according to an aspect of the subject technology. The process may be performed using the processor 110 and the object positioning device 150.

In step 410, a determination is made whether an object is approaching (moving toward) the surface of the screen 220. The object may be a user's finger/hand. If the object is approaching the surface of the screen 220, then the process proceeds to step 420. Otherwise the process repeats step 410.

In step 420, a virtual input device 360 is displayed on the screen 220. The virtual input device 360 may be activated at a particular location on the screen 220 that the user's finger/hand is approaching or other location on the screen 220. In step 430, input is received from the user via the activated virtual input device 360. For example, the user may enter text into the computing device 100 by typing on the virtual input device 360.

In one aspect, the processor 110 may control the opacity of the virtual input device 360 based on the distance of the user's finger/hand from the surface of the screen 220. For example, the processor 110 may increase the opacity of the virtual input device 360 when the user's finger/hand is closer to the surface of the screen 220 and decrease the opacity of the virtual input device 360 when the user's finger/hand is farther away from the surface of the screen 220. The level of opacity of the virtual input device 360 may be proportional to the distance of the user's finger/hand from the surface of the screen 220.

In this aspect, the user may move his/her finger/hand away from the screen 220 to reduce the opacity of the virtual input device 360 enough to make content behind the virtual input device 360 visible. Thus, a user may view content behind the virtual input device 360 by moving his/her finger/hand away from the screen 220 until the content is visible through the virtual input device 360. This allows the user to view content behind the virtual input device 360 without having to close the virtual input device 360.

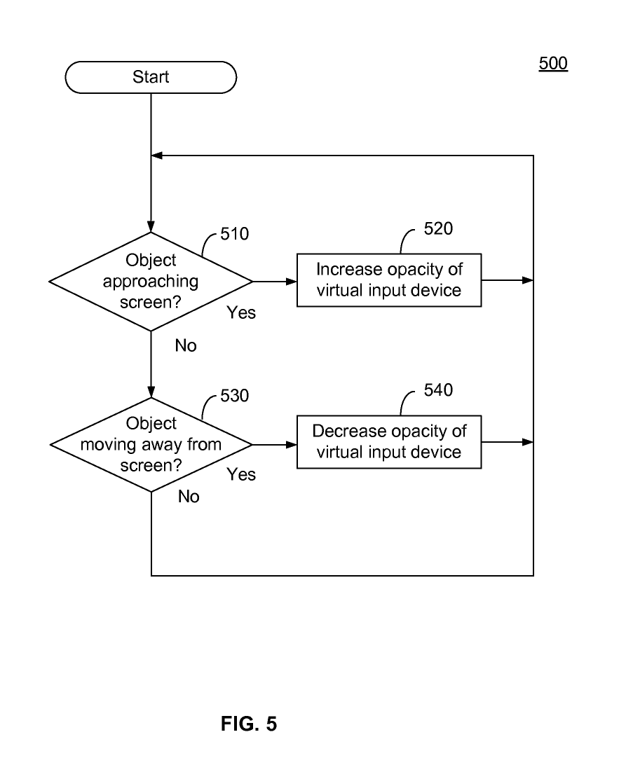

FIG. 5 is a flowchart of a process for controlling the opacity of the virtual input device 360 displayed on the screen 220 according to aspect of the subject technology. The process may be performed using the processor 110 and the object positioning device 150.

In step 510, a determination is made whether the object is approaching the surface of the screen. The object may be a user's finger/hand. If the object is approaching the surface of the screen 220, then the process proceeds to step 520. Otherwise the process proceeds to step 530.

In step 520, the opacity of the virtual input device 360 is increased and the process returns to step 510.

In step 530, a determination is made whether the object is moving away from the surface of the screen. If the object is moving away from the surface of the screen 220, then the process proceeds to step 540. Otherwise the process returns to step 510 with no change in the opacity of the virtual input device.

In step 540, the opacity of the virtual input device 360 is decreased and the process returns to step 510.

In one aspect, the processor 110 may control the opacity of the virtual input device 360 when the user's finger/hand approaches or moves away from a location on the screen corresponding to the virtual input device 360 (e.g., a location within the virtual input device). The processor 110 may decide not to adjust the opacity of the virtual input device when the user's finger/hand approaches a location on the screen 220 located away from the virtual input device such as a location on the screen corresponding to an icon, a scroll bar, a minimize button, a maximize button, or a link on the screen.

In one aspect, the processor 110 may control another attribute of the virtual input device 360 in addition to or in the alternative to the opacity of the virtual input device 360. For example, the processor 110 may control the size of the virtual input device 360 depending on whether the user's finger/hand is approaching or moving away from the surface of the screen. In this example, the processor 110 may increase the size of the virtual input device when the user's finger/hand approaches the surface of the screen and decrease the size of the virtual input device when the user's finger/hand moves away from the surface of the screen. In another example, the processor 110 may adjust the shape of the virtual input device 360 depending on whether the user's finger/hand is approaching or moving away from the surface of the screen.

In one aspect, the processor 110 may determine whether the user's finger/hand is approaching a link displayed on the screen 220. If the processor 110 determines that the user's finger/hand is approaching the link, then the processor 110 may begin retrieving the corresponding content (e.g., webpage) from a network using the link based on the assumption that the user intends to view the content. The processor 110 may retrieve the content by sending a request for the content using an address (e.g., URL) in the link via the network interface 120. In response to the request, the processor 110 may receive the requested content via the network interface 120 and store the content in the memory 115.

In this aspect, the processor 110 may display the stored content on the screen 220 when the user's finger/hand touches the link on the screen 220. Thus, the processor 110 begins retrieving the content when the user's finger/hand approaches the link on the screen 220 without waiting for the user's finger/hand to touch the link on the screen 220. In other words, the processor 110 may preload the content onto the computing device 110 when the user's finger/hand approaches the link on the screen 220.

Thus, the processor 110 may infer that the user intends to view the content corresponding to the link when the processor 110 determines that the user's finger/hand is approaching the link on the screen 220. The processor 110 may make this determination when the user's finger/hand is still located a certain distance away from the surface of the screen 220. The distance may be one centimeter or more, two centimeters or more, three centimeters or more, or four centimeters or more.

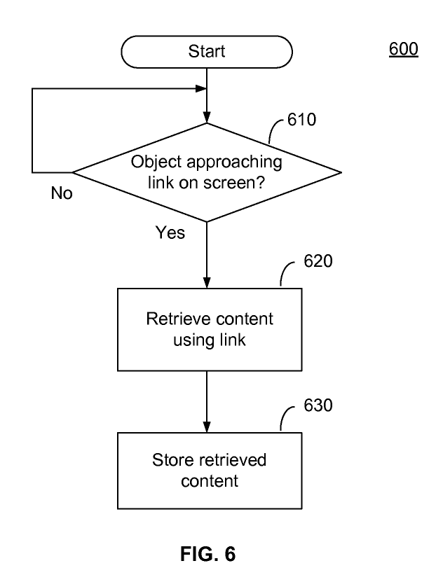

FIG. 6 is a flowchart of a process for loading content onto the computing device 100 according to aspect of the subject technology. The process may be performed using the processor 110 and the object positioning device 150.

In step 610, a determination is made whether an object is approaching a link on the screen 220 of the computing device 100. The object may be a user's finger/hand and the link may be a link to content (e.g., webpage) on a network. If the object is approaching the link on the screen 220, then the process proceeds to step 620. Otherwise the process repeats step 610.

In step 620, the content (e.g., webpage) is retrieved from the network using the link, and in step 630, the retrieved content is stored on the computing device. Thus, the content corresponding to the link may be preloaded onto the computing device 100 when the object (user's finger/hand) is detected approaching the link on the screen 220.

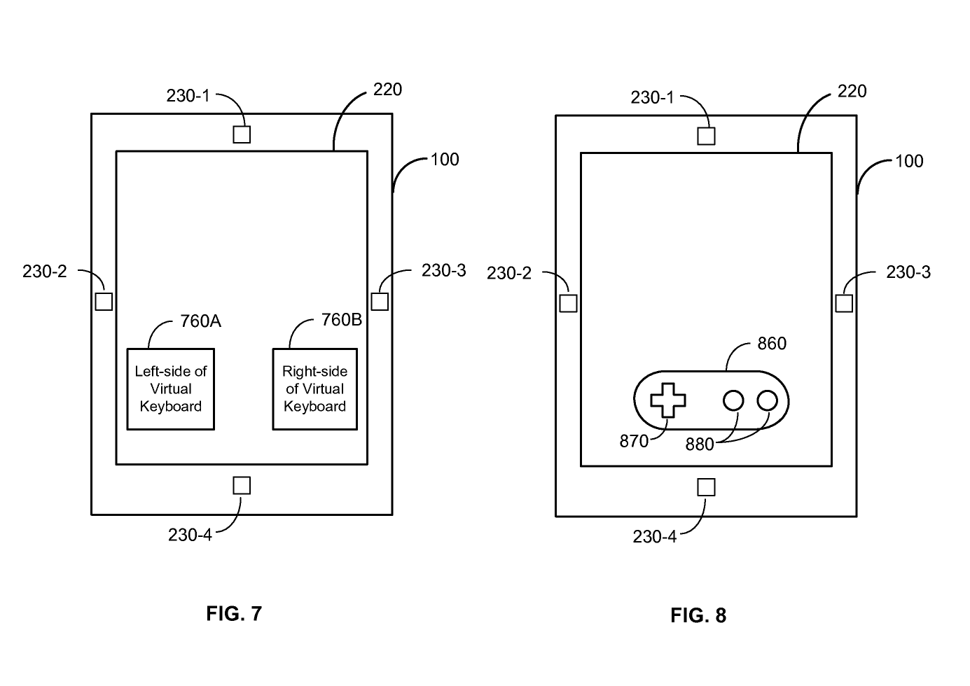

FIG. 7 shows an example of a virtual input device 760A and 760B according to another aspect of the subject technology. In this aspect, the virtual input device 760A and 760B is a split virtual keyboard comprising a left-side portion 760A and a right-side portion 760B separated by a space. The keys of the split virtual keyboard may be approximately equally divided between the left-side portion 760A and the right-side portion 760B.

FIG. 8 shows another example of a virtual input device 860 according to another aspect of the subject technology. In this aspect, the virtual input device 860 is a virtual game controller comprising a virtual joystick 870 and a plurality of control buttons 880. The user may use the virtual input device 860 according to this aspect to play a video game on the computing device 100.

Many of the above-described features and applications may be implemented as a set of machine-readable instructions stored on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this disclosure, the term “software” is meant to include firmware or applications stored in a memory, which can be executed by a processor. Also, in some implementations, multiple software aspects can be implemented as sub-parts of a larger program while remaining distinct software aspects. In some implementations, multiple software aspects can also be implemented as separate programs. Finally, any combination of separate programs that together implement a software aspect described here is within the scope of the disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method for receiving input from a user on a computing device, the method comprising:
determining different distances of an object from a surface of a screen of the computing device at different times;
detecting the object moving toward the screen when the determined distances decrease over a time period;
in response to detecting the object moving toward the screen, displaying a virtual input device on the screen; and
receiving input from the user via the virtual input device.

2. The method of claim 1, further comprising:
detecting the object moving away from the screen; and
in response to detecting the object moving away from the screen, removing the virtual input device from the screen.

3. The method of claim 1, wherein the object comprises a finger or hand.

4. The method of claim 1, wherein detecting the object moving toward the screen comprises detecting the object moving toward an input field on the screen and commencing an action associated with the input field prior to the object touching the screen, and wherein the method further comprises automatically repositioning the input field on the screen so that the input field is visible on the screen when the virtual device is displayed on the screen.

5. The method of claim 4, wherein repositioning the input field comprises automatically scrolling the input field up or down on the screen.

6. The method of claim 4, wherein the input field is an address bar, and wherein the commencing an action includes initiating the loading of the content associated with the address bar.

7. The method of claim 1, wherein detecting the object moving toward the screen comprises detecting the object moving toward the screen when the object is located a distance of one or more centimeters from the screen, and wherein the object comprises a finger or hand of the user or an object that is manipulated by the user.

8. The method of claim 1, further comprising adjusting an opacity of the virtual input device according to a distance of the object from the screen.

9. The method of claim 8, wherein adjusting the opacity of the virtual input device comprises increasing the opacity of the virtual input device when the object is closer to the screen and decreasing the opacity of the virtual input device when the object is farther away from the screen.

10. (canceled)

11. A non-transitory machine-readable medium comprising instructions stored therein, which when executed by a machine, cause the machine to perform operations, the operations comprising:
detecting an object moving toward an input field on a screen of a computing device;
in response to detecting the object moving toward the input field on the screen, automatically repositioning the input field on the screen and displaying a virtual input device on the screen;
receiving text input from the user via the virtual input device; and
entering the text input from the user into the input field on the screen.

12. The machine-readable medium of claim 11, wherein detecting the object moving toward the input field on the screen comprises:
determining a location on the screen that the object is approaching; and
detecting the object moving toward the input field when the determined location corresponds to a location of the input field on the screen.

13. The machine-readable medium of claim 12, wherein displaying the virtual input device on the screen comprises displaying the virtual input device at the determined location on the screen, and wherein automatically repositioning the input field comprises automatically repositioning the input field away from the determined location on the screen so that the input field is visible on the screen when the virtual input device is displayed on the screen.

14. The machine-readable medium of claim 13, wherein automatically repositioning the input field comprises automatically scrolling the input field up or down on the screen.

15. The machine-readable medium of claim 11, wherein detecting the object moving toward the input field comprises detecting the object moving toward the input field when the object is located a distance of one or more centimeters from the screen, and wherein the object comprises a finger or hand of the user or an object that is manipulated by the user.

16. A system for receiving input from a user, comprising:
one or more processors; and
a machine-readable medium comprising instructions stored therein, which when executed by the one or more processors, cause the one or more processors to perform operations, the operations comprising:
detecting a finger or hand of the user moving toward a screen of a computing device;
in response to detecting the finger or hand moving toward the screen, displaying a virtual input device on the screen;
receiving input from the user via the virtual input device;
determining a distance of the finger or hand from the screen; and
adjusting an opacity of the virtual input device as a function of the determined distance of the finger or hand from the screen.

17. The system of claim 16, wherein detecting the finger or hand of the user moving toward the screen comprises detecting the finger or hand of the user moving toward the screen when the finger or hand of the user is located a distance of one or more centimeters from the screen.

18. (canceled)

19. The system of claim 16, wherein adjusting the opacity of the virtual input device comprises increasing the opacity of the virtual input device when the finger or hand is closer to the screen and decreasing the opacity of the virtual input device when the finger or hand is farther away from the screen.

20. A computer-implemented method for controlling an opacity of a virtual input device displayed on a computing device, the method comprising:
determining a distance of an object from a screen of the computing device; and
adjusting the opacity of the virtual input device as a function of the determined distance of the object from the screen of the computing device.

21. The method of claim 20, wherein adjusting the opacity of the virtual input device comprises increasing the opacity of the virtual input device when the object is closer to the screen and decreasing the opacity of the virtual input device when the object is farther away from the screen.

22. The method of claim 21, wherein determining the distance of the object from the screen comprises determining the distance of the object from the screen when the object is located a distance of one or more centimeters from the screen, and wherein the object comprises a finger or hand of the user or an object that is manipulated by the user.

23. The method of claim 20, wherein the object comprises a finger or a hand.

24. The method of claim 1, wherein the virtual input device comprises a virtual keyboard.

25. The machine readable-medium of claim 11, wherein the virtual input device comprises a virtual keyboard.

26. The system of claim 16, wherein the opacity of the virtual input device is proportional to the determined distance of the finger of hand from the screen.

27. The method of claim 20, wherein the opacity of the virtual input device is proportional to the determined distance of the object from the screen.
